(19) United States
(12) Patent Application Publication
(10) Pub. No.: US 2014/0095315 A1
(43) Pub. Date: Apr. 3, 2014

(54) MOBILE DEVICE WITH REVEAL OF DYNAMIC CONTENT

(71) Applicants: Siva G. Narendra, Portland, OR (US); Donald Allen Bloodworth, Camas, WA (US)

(72) Inventors: Siva G. Narendra, Portland, OR (US); Donald Allen Bloodworth, Camas, WA (US)

(21) Appl. No.: 13/630,342

(22) Filed: Sep. 28, 2012

(51) Int. Cl. G06Q 30/02

(52) U.S. Cl. 705/14.64

(57) ABSTRACT

A mobile device displays a page-turn icon with abbreviated dynamic content. When a user interacts with the page-turn icon, additional dynamic content is revealed. Dynamic content may be selected and/or controlled by an operating system or a mobile application. Analytics may be collected that describe user behaviour when interacting with the dynamic content.

### FIELD

The present invention relates generally to mobile devices, and more specifically to user interfaces in mobile devices.

### BACKGROUND

Mobile devices with touch sensitive displays typically display banner advertisements within applications. Banner advertisements consume valuable space on the mobile device display screen, and many users find them annoying. Operating system vendors and application program vendors have an interest in displaying advertisements on mobile devices because they generate revenue, but vendors also have to be careful not to upset users by making the banner advertisements too large.

### BRIEF DESCRIPTION OF THE DRAWINGS

FIG. 1 shows a mobile device displaying a page-turn icon with abbreviated dynamic content;

FIGS. 2 and 3 show mobile devices with dynamic content that has been revealed;

FIG. 4 shows user interaction with a page-turn icon and revealed dynamic content;

FIG. 5 shows user interaction with a transparent icon;

FIGS. 6 and 7 show block diagrams of mobile devices in accordance with various embodiments of the present invention; and

FIG. 8 shows a flowchart of methods in accordance with various embodiments of the present invention.

### DESCRIPTION OF EMBODIMENTS

In the following detailed description, reference is made to the accompanying drawings that show, by way of illustration, various embodiments of an invention. These embodiments are described in sufficient detail to enable those skilled in the art to practice the invention. It is to be understood that the various embodiments of the invention, although different, are not necessarily mutually exclusive. For example, a particular feature, structure, or characteristic described in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

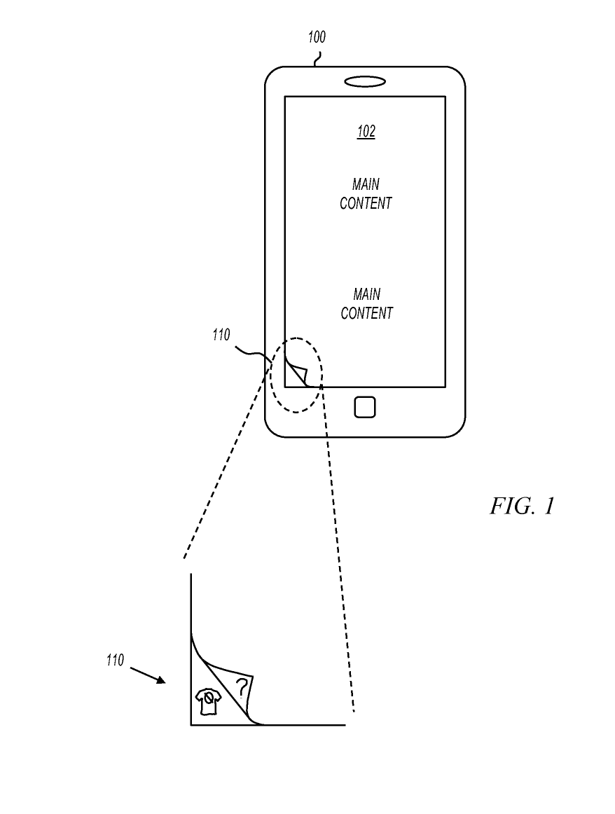

FIG. 1 shows a mobile device displaying a page-turn icon with abbreviated dynamic content. Mobile device 100 includes touch sensitive display device 102. Touch sensitive display device 102 may display content (e.g., icons, text, images, video, etc.) and may also recognize user interaction through touch.

In FIG. 1, touch sensitive display device 102 is shown displaying main content and a page turn icon 110. As used herein, the term “main content” refers to display contents that typically occupy the majority of the display space, and garners the majority of the user's attention. Examples of main content include an operating system generated desktop screen that displays icons and widgets, and operating system generated home screens and lock screens. Another example of main content is an application generated screen that includes application specific information such as weather, email, banking, or contact information.

Touch sensitive display device 102 is also shown with page-turn icon 110. Page-turn icon 110 is an icon that signifies to a user that further information resides “behind” the main content if the page is turned. In some embodiments, page-turn icon 110 includes abbreviate dynamic content. For example, as shown in FIG. 1, page-turn icon 110 includes an image of a shirt and a question mark located in “page behind” and “folded page” locations, respectively. The abbreviated dynamic content may include any combination of content in the “page behind” and “folded page” locations. For example, the abbreviated dynamic content can include any combination of dynamic color, text, or imagery in one or both of the “page behind” and “folded page” locations within page-turn icon 110. The dynamic content displayed by page-turn icon 110 is referred to as “abbreviated” because if the page is turned, more dynamic content is revealed. The content displayed by page-turn icon 110 is referred to as “dynamic” because the information may change as a function of time. In these embodiments, when a user interacts with page-turn icon 110 by touching or swiping in the icon's vicinity, additional dynamic content is revealed from “behind” the main content. As used herein the term “behind” is used in a logical sense rather than a physical sense. The additional dynamic content is not physically behind the main content; rather, it logically appears to be behind the main content because of the position, shape, and movement of various graphical elements displayed.

In some embodiments, the abbreviated dynamic content includes advertising content. For example, the abbreviated dynamic content shown in FIG. 1 represents abbreviated advertising content for a clothing distributor. The abbreviated advertising content (and icon 110) are shown in the lower left corner of touch sensitive display device 102, although this is not a limitation of the present invention. Page-turn icons and abbreviated dynamic content may appear anywhere in the display space without departing from the scope of the present invention. Further, the abbreviated dynamic content may include dynamic color, text, imagery, or any combination thereof.

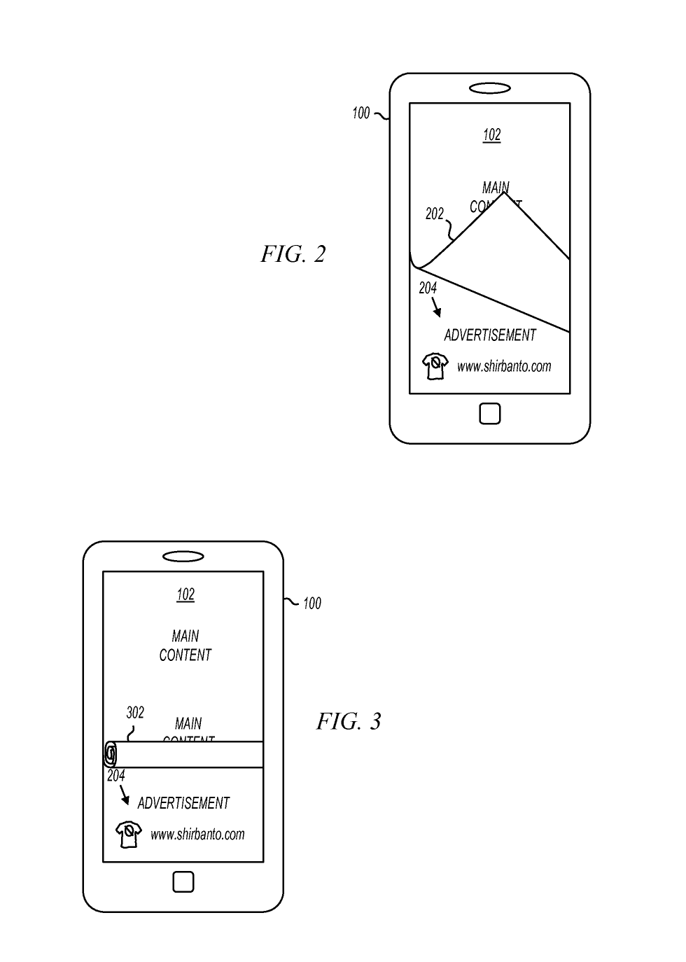

FIGS. 2 and 3 show mobile devices with dynamic content that has been revealed. As shown in FIG. 2, the page-turn icon 110 is no longer present, and instead, a partial page turn effect 202 is displayed. The partial page turn effect 202 reveals additional dynamic content 204, and covers portions of the main content. Partial page turn effect 202 provides the effect that additional dynamic content 204 residing behind the main content has been revealed by the partial page turn. For purposes of this description, a fictitious clothing distributor “shirbanto” is shown as the provider of the additional dynamic content.

In some embodiments, partial page turn effect 202 results from user interaction with page-turn icon 110. For example, partial page turn effect 202 may be displayed when a user touches or swipes page-turn icon 110.

Various embodiments of the present invention allow a provider of dynamic content to effectively balance the use of display screen space with the desire to display content, especially advertising. As shown in FIGS. 1 and 2, various embodiments of the invention display a page-turn icon with abbreviated dynamic content rather than a banner advertisement being displayed alongside main content. The mobile device user still has access to the additional dynamic content when desired through interaction with the page-turn icon; however, the user is not forced to always view a full banner ad.

In some embodiments, analytics are gathered regarding users' interaction with page-turn icons. For example, when a user interacts with a page-turn icon to reveal a specific advertisement based on the abbreviated dynamic content, this data may be collected. In this manner, the analytics may collect data representing user likes and dislikes with respect to specific advertisements without requiring the user to click through to an advertiser's website. For example, a user might be willing to reveal additional dynamic content for an interesting looking advertisement, but may not be willing to click through to a website. This represents valuable analytic data that is not available when only banner ads requiring click through are present.

In some embodiments, decisions as to what information is included in abbreviated dynamic content and additional dynamic content (e.g., what ad is to be displayed) may be based on the color, text, or imagery displayed in the current main content or any previously viewed main content, collected analytics, or any combination. For example, if a mobile device user is viewing a Mobile Banking application's car loan page, the dynamic content decision making process could result in the display of an advertisement for a new car loan application. In some embodiments, the decision is based on an anticipated need related to, but not directly connected to, the current main content, previous main content, or previously collected analytics. For example, if a mobile device user is viewing a page to order or reorder diet pills, the decision making process could result in dynamic content relating to ordering a new pair of pants in anticipation that the user has lost or will lose weight. In some embodiments, the decision making process may be a function of time of day, location, sound, speed, and direction. In some embodiments, the decision making process is solely performed locally in the mobile device, or solely performed by a remotely connected server or any combination thereof. In some embodiments, the decision making process is performed by the operating system or the application developer, or a third party service provider.

FIG. 3 shows a partial page roll effect 302 that reveals additional dynamic content 204. In some embodiments, partial page roll effect 302 is displayed when a user interacts with a page-turn icon. Any graphical effect may be utilized to reveal additional dynamic content without departing from the scope of the present invention. Partial page turn effect 202 and partial page roll effect 302 are provided as examples, and are not meant to limit the various embodiments of the present invention.

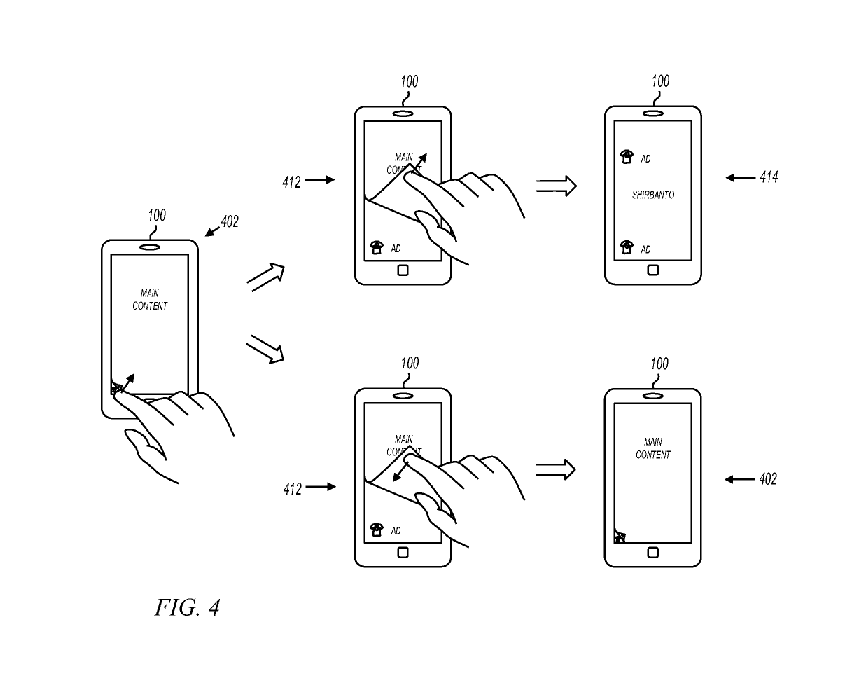

FIG. 4 shows user interaction with a page-turn icon and revealed dynamic content. Mobile device 100 is shown in various states denoted by reference numerals 402, 412, and 414. State 402 corresponds to the state shown in FIG. 1 in which main content is displayed on the touch sensitive display device, and a page-turn icon is displayed in the lower left corner. A user is shown interacting with the page-turn icon. In some embodiments, the user may touch the icon, and in other embodiments, the user may swipe in the direction shown.

As a result of the user interaction with the page-turn icon, mobile device 100 enters state 412 by performing a reveal of additional dynamic content. In some embodiments, analytics are gathered regarding the user interaction with the page-turn icon and the abbreviated dynamic content displayed on the page-turn icon (if any). State 412 shows a partial page turn effect, although this is not a limitation of the present invention. The revealing of additional dynamic content may be performed using a graphical effect other than a partial page turn.

In some embodiments, the mobile device user has multiple options when additional dynamic content has been revealed. For example, a user may reverse the reveal of additional dynamic content, may continue the reveal to display a full page of dynamic content, or may click through to an advertiser's website. As shown at the top center of FIG. 4, the user interacts with the partial page turn effect to complete the reveal of the additional dynamic content. As shown at the bottom center of FIG. 4, the user interacts with the partial page turn effect to reverse the reveal of the additional dynamic content.

In some embodiments, analytics are gathered for each user interaction shown in FIG. 4. This provides valuable analytic data regarding user preferences without requiring a user to click through to an advertiser's website.

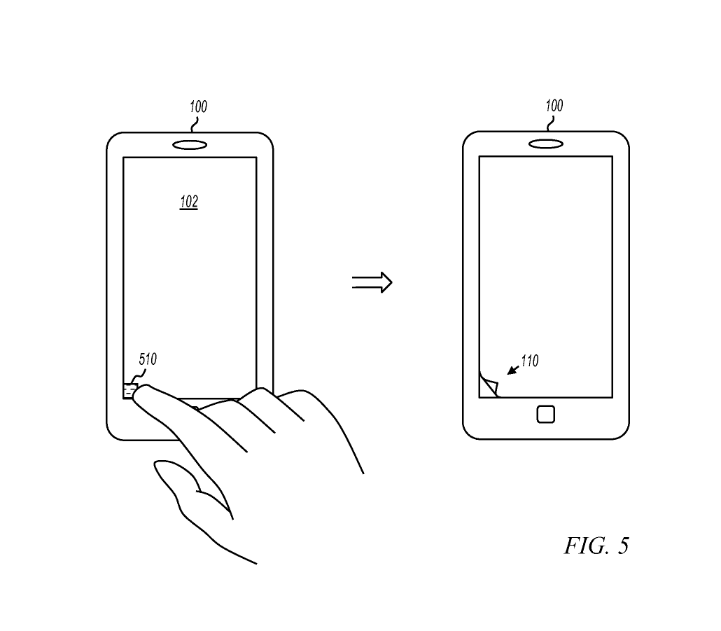

FIG. 5 shows user interaction with a transparent icon. Mobile device 100 is shown displaying a transparent icon 510 on the lower left corner of touch sensitive display device 102. In some embodiments, transparent icon 510 may include information that lets the user know that dynamic content is available. If the user wishes to not view any dynamic content, then the user has the option of ignoring transparent icon 510 and still being able to view all of the main content including that which is behind transparent icon 510. If the user wishes to view (or preview) dynamic content, the user may interact with the transparent icon to cause the mobile device to display page-turn icon 110 with abbreviated dynamic content.

In some embodiments, transparent icon 510 includes a partially transparent image that provides the user with an indication of the dynamic contents. For example, a partially transparent shirt may be shown on transparent icon 510 when the dynamic content includes the shirbanto advertisement used as an example in previous figures. In some embodiments, the transparent icon is static, and in other embodiments, the transparent icon is dynamic. For example, the transparent icon may include dynamic colors, text, or images.

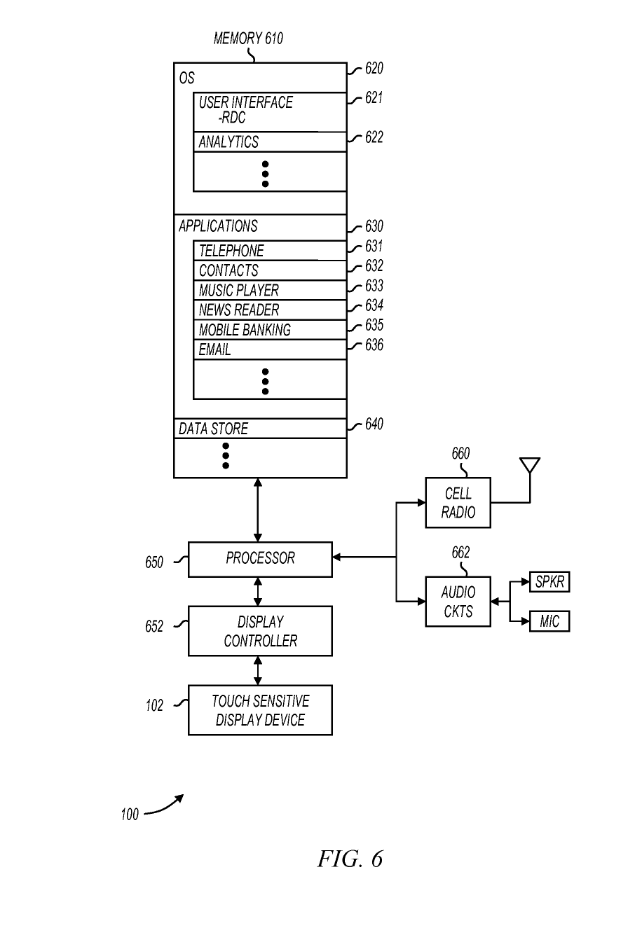

FIG. 6 shows a mobile device in accordance with various embodiments of the present invention. Mobile device 100 includes processor 650, memory 610, display controller 652, touch sensitive display device 102, cellular radio 660, and audio circuits 662. Mobile device 100 may be any type of mobile device that includes the components shown. For example, in some embodiments, mobile device 100 may be a cell phone, a smartphone, a tablet computer, a laptop computer, or the like.

Processor 650 may be any type of processor capable of executing instructions store in memory 610 and capable of interfacing with the various components shown in FIG. 6. For example, processor 650 may be a microprocessor, a digital signal processor, an application specific processor, or the like. In some embodiments, processor 650 is a component within a larger integrated circuit such as a system on chip (SOC) application specific integrated circuit (ASIC).

Display controller 652 provides an interface between processor 650 and touch sensitive display device 102. In some embodiments, display controller 652 is integrated within processor 650, and in other embodiments, display controller 652 is integrated within touch sensitive display device 102.

Touch sensitive display device 102 is a display device that includes a touch sensitive surface, sensor, or set of sensors that accept input from a user. For example, touch sensitive display device 102 may detect when and where an object touches the screen, and may also detect movement of an object across the screen. When touch sensitive display device 102 detects input, display controller 652 and processor 650 (in association with user interface component 621) determine what actions to perform.

Touch sensitive display device 102 may be manufactured using any applicable display technologies, including for example, liquid crystal display (LCD), active matrix organic light emitting diode (AMOLED), and the like. Further, touch sensitive display device 102 may be manufactured using any application touch sensitive input technologies, including for example, capacitive and resistive touch screen technologies, as well as other proximity sensor technologies.

Cellular radio 660 may be any type of radio that can communicate within a cellular network. Examples include, but are not limited to, radios that communicate using orthogonal frequency division multiplexing (OFDM), code division multiple access (CDMA), time division multiple access (TDMA), and the like. Cellular radio 660 may operate at any frequency or combination of frequencies without departing from the scope of the present invention. In some embodiments, cellular radio 660 is omitted.

Audio circuits 662 provide an interface between processor 650 and audio devices such as a speaker and microphone.

Mobile device 100 may include many other circuits and services that are not specifically shown in FIG. 6. For example, in some embodiments, mobile device 100 may include a global positioning system (GPS) radio, a Bluetooth radio, haptic feedback devices, and the like. Any number and/or type of circuits and services may be included within mobile device 100 without departing from the scope of the present invention.

Memory 610 may include any type of memory device. For example, memory 610 may include volatile memory such as static random access memory (SRAM), or nonvolatile memory such as FLASH memory. Memory 610 is encoded with (or has stored therein) one or more software modules (or sets of instructions), that when accessed by processor 650, result in processor 650 performing various functions. Memory 610 is an example a nontransitory computer readable medium that stores instructions readable by a computer when the computer performs a computer-implemented method. In some embodiments, processor 650 functions as a computer performing the computer-implemented method. In other embodiments, mobile device 100 functions as the computer performing the computer-implemented method.

In some embodiments, the software modules stored in memory 610 may include an operating system (OS) 620 and applications 630. Applications 630 may include any number or type of applications. Examples provided in FIG. 6 include a telephone application 631, a contacts application 632, a music player application 633, a news reader application 634, a mobile banking application 635, and an email application 636. Memory 610 may also include any amount of space dedicated to data storage 640.

Operating system 620 may be a mobile device operating system such as an operating system to control a mobile phone, smartphone, tablet computer, laptop computer, or the like. As shown in FIG. 6, operating system 620 includes user interface component 621 and analytics component 622. Operating system 620 may include many other components without departing from the scope of the present invention.

User interface component 621 includes processor instructions that cause mobile device 100 to display desktop screens, recognize gestures, and provide navigation between desktop screens. User interface 621 is a graphical user interface that also includes instructions to display menus, move icons, and manage other portions of the display environment.

In some embodiments, user interface 621 includes a component to reveal dynamic content (RDC component). For example, user interface 621 may include instructions that cause processor 650 to display various icons with abbreviated dynamic content, as well as graphical effects that reveal additional dynamic content in response to user interaction with icons. In some embodiments, the RDC component is provided as an application programming interface (API) so that applications can control the display of transparent icons, page-turn icons, abbreviated dynamic content, and page turn effects, as well as control the reveal of additional dynamic content.

Operating system 620 also includes analytics component 622. Analytics component 622 includes instructions that cause processor 650 to gather data regarding user interaction with icons and dynamic content. For example, data may be collected each time a user interacts with a transparent icon, a page-turn icon with abbreviated dynamic content, or a page turn effect that has been displayed to reveal additional dynamic content. The data collected may be stored in data store 640, and may be transmitted to a third party via cellular radio 660.

Telephone application 631 may be an application that controls a cell phone radio. Contacts application 632 includes software that organizes contact information. Contacts application 632 may communicate with telephone application 631 to facilitate phone calls to contacts. Music player application 633 may be a software application that plays music files that are stored in data store 640.

Mobile banking application 635 may be a software application that communicates with a banking service to allow banking functions such as balance inquiries, funds transfers, bill payment and the like. Mobile banking application 635 may be a downloaded “thick” application, or may be a “thin” application that uses internet browser functionality. Other application examples include applications that store an identity such as a passport or a building access identity.

Each of the above-identified applications correspond to a set of instructions for performing one or more functions described above. These applications (sets of instructions) need not be implemented as separate software programs, procedures or modules, and thus various subsets of these applications may be combined or otherwise re-arranged in various embodiments. For example, telephone application 631 may be combined with contacts application 632. Furthermore, memory 610 may store additional applications (e.g., video players, camera applications, etc.) and data structures not described above.

Transparent icons, page-turn icons, abbreviated dynamic content and effects that reveal additional dynamic content may be displayed while any application has control of the contents of touch sensitive display device 102. In some embodiments, user interface 621 controls these display elements while applications are using the display. In other embodiments, applications control these elements through an API provided by operating system 620. Further, the dynamic content itself may be controlled by the operating system, any application, or a third party. For example, in some embodiments, the dynamic content includes advertising, the display of which is controlled by an application. In other embodiments, the operating system may allow a third party to dictate what is included in the dynamic content.

It should be noted that device 100 is presented as an example of a mobile device, and that device 100 may have more or fewer components than shown, may combine two or more components, or may have a different configuration or arrangement of components. For example, mobile device 100 may include many more components such as sensors (optical, touch, proximity etc.), or any other components suitable for use in a mobile device.

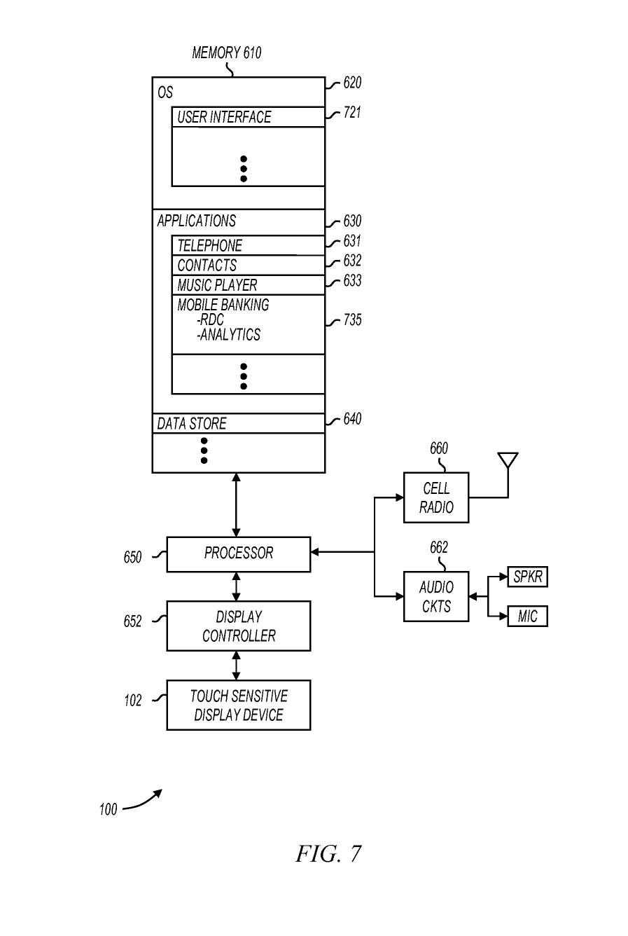

FIG. 7 shows a block diagram of a mobile device in accordance with various embodiments of the present invention. FIG. 7 differs from FIG. 6 in that the RDC component and analytics are included in an application rather than the operating system (user interface 721). As shown in FIG. 7, mobile banking application 735 includes the RDC component and analytics. In embodiments represented by FIG. 7, mobile banking application 735 has complete control over the user of transparent icons, page-turn icons with abbreviate dynamic content, and the reveal of additional dynamic content.

In some embodiments, mobile banking application 735 only transparent icons or page-turn icons on certain display screens. For example, a page-turn icon with abbreviated advertising content may be displayed on a home screen, but may be omitted when bank balance information is displayed.

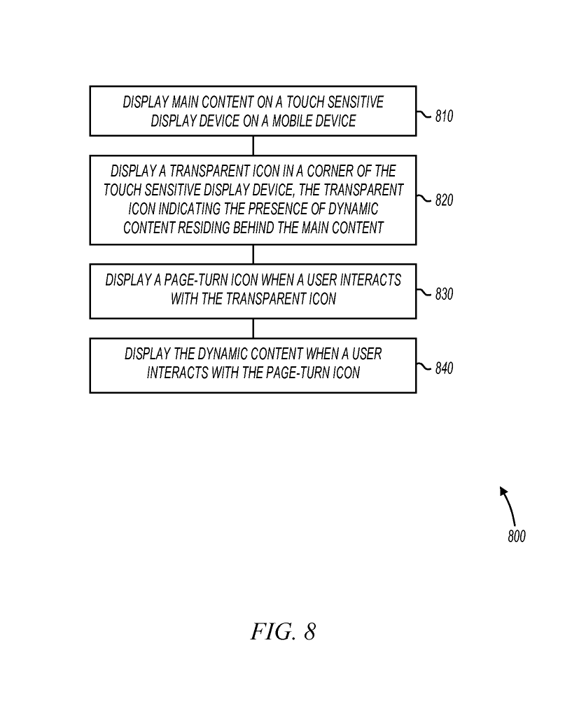

FIG. 8 shows a flowchart of methods in accordance with various embodiments of the present invention. In some embodiments, method 800 may be performed by a mobile device such as mobile devices 100. Further, in some embodiments, method 800 may be performed by a processor that is executing software such as user interface component 621 and/or an application such as mobile banking application 735. Method 800 is not limited by the type of system or entity that performs the method. The various actions in method 800 may be performed in the order presented, in a different order, or simultaneously. Further, in some embodiments, some actions listed in FIG. 8 are omitted from method 800. In some embodiments, method 800 is a method to manage dynamic content on a mobile device. For example, method 800 includes methods to manage advertising content on a mobile device.

Method 800 begins at 810 in which main content is displayed on a touch sensitive display device. The main content includes information provided by an operating system, an application, or the like. For example, the main content may include icons, widgets, text, or any other suitable information.

At 820, a transparent icon is displayed in a corner of the touch sensitive display device. The transparent icon indicates the presence of dynamic content residing behind the main content. In some embodiments, the transparent icon may be static, and in other embodiments, the transparent icon may be dynamic.

At 830, a page-turn icon is displayed when a user interacts with the transparent icon. In some embodiments, the page-turn icon includes abbreviated dynamic content. The abbreviated dynamic content may be for any purpose. For example, the abbreviated dynamic content may include advertisements, offers, alerts, or the like. Further the abbreviated dynamic content may include dynamic colors, images, text, or the like.

At 840, the dynamic content is displayed when a user interacts with the page-turn icon. In some embodiments, the actions of 840 include turning at least a portion of the content as a page. This may be accomplished by displaying a partial page turn effect as shown in FIG. 2. Further, in some embodiments, the actions of 840 include displaying an advertising banner.

In embodiments in which the dynamic content includes a hyperlink, a mobile device user may interact with the dynamic content. For example, a user may click through an advertisement included within the dynamic content.

In some embodiments, analytics are collected throughout the operation of method 800. For example, data may be collected when a user interacts with transparent icons, page-turn icons, page-turn effects, dynamic content, or any combination.

Method 800 is an example of a computer-implemented method. In some embodiments, the computer-implemented method is performed when a computer or processor accesses instructions stored in a non-transitory computer readable storage medium such as memory 610 (FIG. 6).

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A mobile device comprising:
a processor;
a touch sensitive display device;
a memory; and
a program, wherein the program is stored in the memory and configured to be executed by the processor, the program including instructions for:
displaying a page-turn icon with abbreviated advertising content in a corner of the touch sensitive display device; and
performing a reveal of advertising content when a user interacts with the page-turn icon.

2. The mobile device of claim 1 wherein performing a reveal comprises performing a partial page turn of contents displayed on the touch sensitive display device.

3. The mobile device of claim 1 wherein the program further includes instructions for collecting analytics regarding user interaction with the page-turn icon.

4. The mobile device of claim 1 wherein the program further includes instructions for displaying a transparent icon in the corner of the touch sensitive display device, and displaying the page-turn icon when the user interacts with the transparent icon.

5. The mobile device of claim 1 wherein the program comprises an application program.

6. The mobile device of claim 1 wherein the program comprises an operating system.

7. A computer-implemented method to manage dynamic content on a mobile device comprising:
displaying main content on a touch sensitive display device on the mobile device;
displaying a transparent icon in a corner of the touch sensitive display device, the transparent icon indicating the presence of the dynamic content residing behind the main content;
displaying a page-turn icon when a user interacts with the transparent icon; and
displaying the dynamic content when a user interacts with the page-turn icon.

8. The computer implemented method of claim 7 wherein the transparent icon is static.

9. The computer implemented method of claim 7 wherein the transparent icon is dynamic.

10. The computer implemented method of claim 7 wherein the dynamic content comprises advertising content.

11. The computer implemented method of claim 8 wherein the page-turn icon includes abbreviated advertising content.

12. A computer-implemented method to manage advertising content on a mobile device comprising:
displaying main content on a touch sensitive display device on the mobile device;
displaying an icon in a corner of the touch sensitive display device, the icon indicating the presence of the advertising content residing behind the main content; and
displaying the advertising content when a user interacts with the icon.

13. The computer implemented method of claim 12 wherein the icon comprises a page-turn icon.

14. The computer implemented method of claim 13 wherein displaying the advertising content when a user interacts with the page-turn icon comprises turning at least a portion of the main content as a page.

15. The computer implemented method of claim 13 wherein the page-turn icon includes abbreviated advertising content.

16. The computer implemented method of claim 13 wherein the page-turn icon includes dynamic abbreviated advertising content.

17. The computer implemented method of claim 12 further comprising collecting analytics regarding users interacting with the icon to access the advertising content.

18. The computer implemented method of claim 17 further comprising collecting information regarding users clicking through the advertising content.

19. The computer implemented method of claim 12 wherein the main content comprises content generated by an application program running on the mobile device.

20. The computer implemented method of claim 12 wherein the main content comprises content generated by an operating system running on the mobile device.

21. A non-transitory computer readable storage medium storing one or more programs comprising instructions, which when executed by a mobile device with a touch sensitive display device, cause the mobile device to:
display main content on the touch sensitive display device;
display a page-turn icon in a corner of the touch sensitive display, the page-turn icon indicating the presence of advertising content residing behind the main content; and
display the advertising content when a user interacts with the page-turn icon.

22. The non-transitory computer readable storage medium of claim 21 wherein the page-turn icon includes dynamic abbreviated advertising content.

23. The non-transitory computer readable storage medium of claim 22 wherein the dynamic abbreviated advertising content comprises a dynamic color.

24. The non-transitory computer readable storage medium of claim 22 wherein the dynamic abbreviated advertising content comprises dynamic text.

25. The non-transitory computer readable storage medium of claim 22 wherein the dynamic abbreviated advertising content comprises a dynamic image.

26. The non-transitory computer readable storage medium of claim 21 wherein the main content comprises content generated by an application.

27. The non-transitory computer readable storage medium of claim 21 wherein the main content comprises content generated by an operating system.

28. A graphical user interface on a portable electronic device with a touch screen display, the graphical user interface comprising:
a page-turn icon that includes abbreviated advertising content; and
an advertising banner that appears when a user interacts with the page-turn icon.

29. The graphical user interface of claim 28 further comprising a page-turn effect to reveal the advertising banner when the user interacts with the page-turn icon.

30. The graphical user interface of claim 28 further comprising an analytics component that records user interaction with the page-turn icon.
